(19) United States
(12) Patent Application Publication
(10) Pub. No.: US 2002/0167196 A1
(43) Pub. Date: Nov. 14, 2002

(54) Swinging disturbing current board for car

(76) Inventor: Jeng-Sheng Huang, Chung-Ho City (TW)

Correspondence Address: Jeng-Sheng Huang, P.O.Box 1-252, Sanchung City, TW

(21) Appl. No.: 10/090,565

(22) Filed: Mar. 3, 2002

(30) Foreign Application Priority Data
May 8, 2001 (TW) 90213948

(51) Int. Cl. B62D 35/00

(52) U.S. Cl. 296/180.5; 340/479

(57) ABSTRACT

The present invention is related to a swinging disturbing current board for car and particularly to a swinging disturbing current board for car which is characterized in the disturbing current board body capable of swinging the rear edge thereof to raise up about 30°-60° in an inclined state from its original slightly horizontal state and to light the third stop light disposed on the said rear edge through the actuation of a disturbing current board driving mechanism installed in a holder on one side of the said current board body when starting up the car and foot-operating the brake while driving the car forward, and mainly consists of a disturbing current board body and left and right holders wherein a disturbing current board driving mechanism is disposed on a fixed beam in the holder on one side thereof and such driving mechanism comprises a motor with a decelerating device, an upper chain wheel, a lower chain wheel, a chain, a relay, an upper limit switch, a lower limit switch and a starting capacitor.

### BACKGROUND OF THE INVENTION

1) Field of the Invention

The invention herein is related to a swinging disturbing current board for car and particularly to a swinging disturbing current board for car which is characterized in the disturbing current board body capable of swinging the rear edge thereof to raise up about 30°-60° in an inclined state from its original slightly horizontal state and to light the third stop light disposed on the said rear edge through the actuation of a disturbing current board driving mechanism installed in a holder on one side of the said current board body when starting up the car and foot-operating the brake while driving the car forward.

2) Description of the Prior Art

The conventional disturbing current boards for car, no matter they are horizontal or inclined with a proper angle or arcked with a slightly raising rear edge, are in a “fixed” state. They are fixed on the rear trunk lid of the car or in a position nearby the rear end (side) thereof, in an unadjustable angle or an unchangeable angle of installation without the sense of novelty, unable to particularly remind the cars behind and helpless to the safety of driving the car, so the users of said boards are rather limited.

Recently there is an adjustable disturbing current board for car wherein the angle of installing the disturbing current board body is adjustable according to the different cars. However, this adjustable disturbing current board for car fixed on the rear trunk lid of the car or in a position nearby the rear end (side) thereof is in a “fixed” state, no matter it is slightly horizontal or its rear edge slightly raises up to a proper angle; so during utilization of such disturbing current board, its angle is unchangeable or unadjustable and it is unswingable without any sense of novelty and unable to particularly remind the cars behind and to promote the safety of driving the car; therefore, the users thereof remain quite limited.

The inventor of the present invention is a professional modifier, maker and seller of various disturbing current boards and vehicle bodies for a number of years. In view of the drawbacks of installing and using the foregoing various conventional disturbing current boards for car, their sales are rather limited and it is difficult to export them to overseas markets, he invented the present invention of a swinging disturbing current board for car through his research and development.

### SUMMARY OF THE INVENTION

The objective of the present invention is to offer a swinging disturbing current board for car which is characterized in the disturbing current board body capable of swinging the rear edge thereof to raise up about 30°-60° in an inclined state from its original slightly horizontal state and to light the third stop light disposed on the said rear edge through the actuation of a disturbing current board driving mechanism installed in a holder on one side of the said current board body when starting up the car and foot-operating the brake while driving the car forward. Therefore the present invention is rather novel and able to remind the cars behind braking in time for the safety of driving the car, and the car users are willing to install and use the present invention.

### BRIEF DESCRIPTION OF THE DRAWINGS

FIG. 1 is a front elevation view and a partial section view (right holder omitted) of the present invention.

FIG. 2 is a rear elevation view and a partial section view (right holder omitted) of the present invention.

FIG. 3 is an elevation breakdown view of the present invention.

FIG. 4 is a partial elevation view of the disturbing current board driving mechanism of the present invention.

FIG. 5 is a schematic diagram of wiring of the present invention.

FIG. 6 is an optional view of operation of the present invention.

### DETAILED DESCRIPTION OF THE INVENTION

An example of the present invention is hereby described in detail in reference to the drawings as follows:

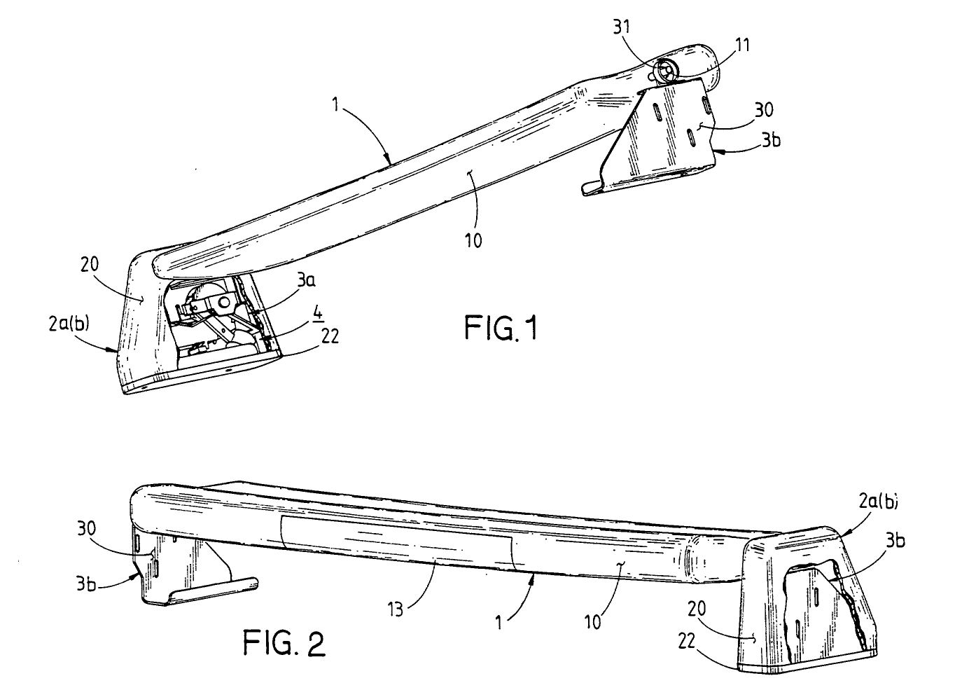

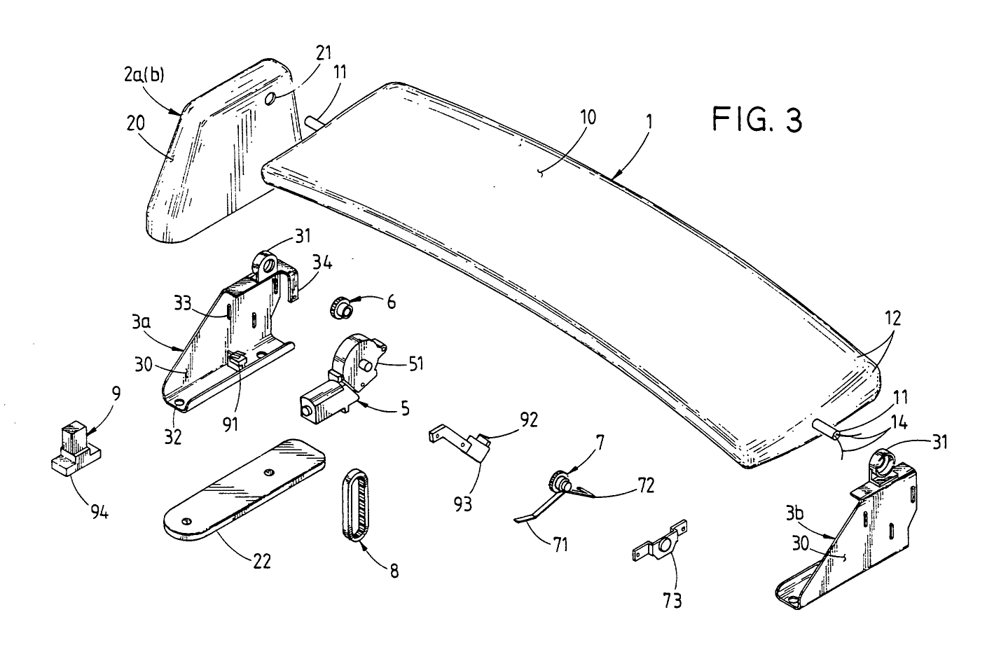

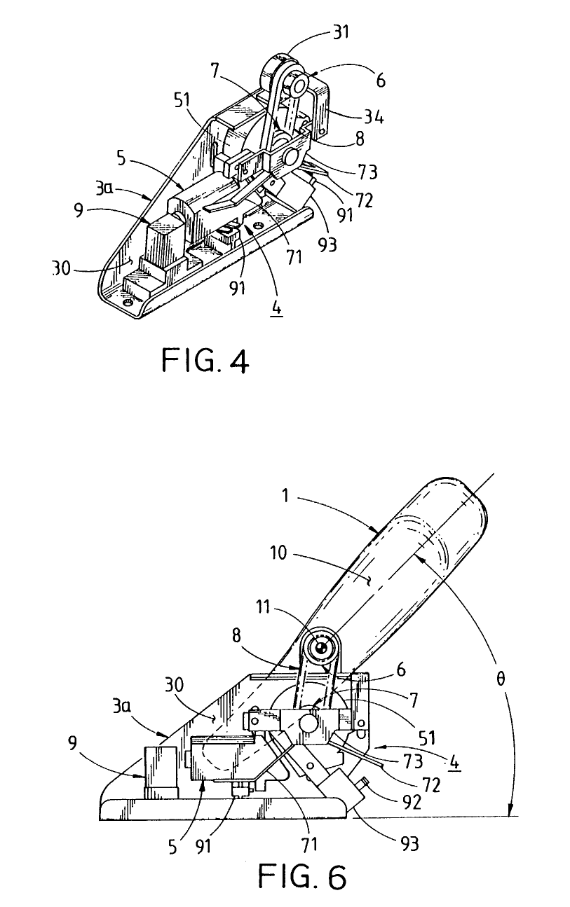

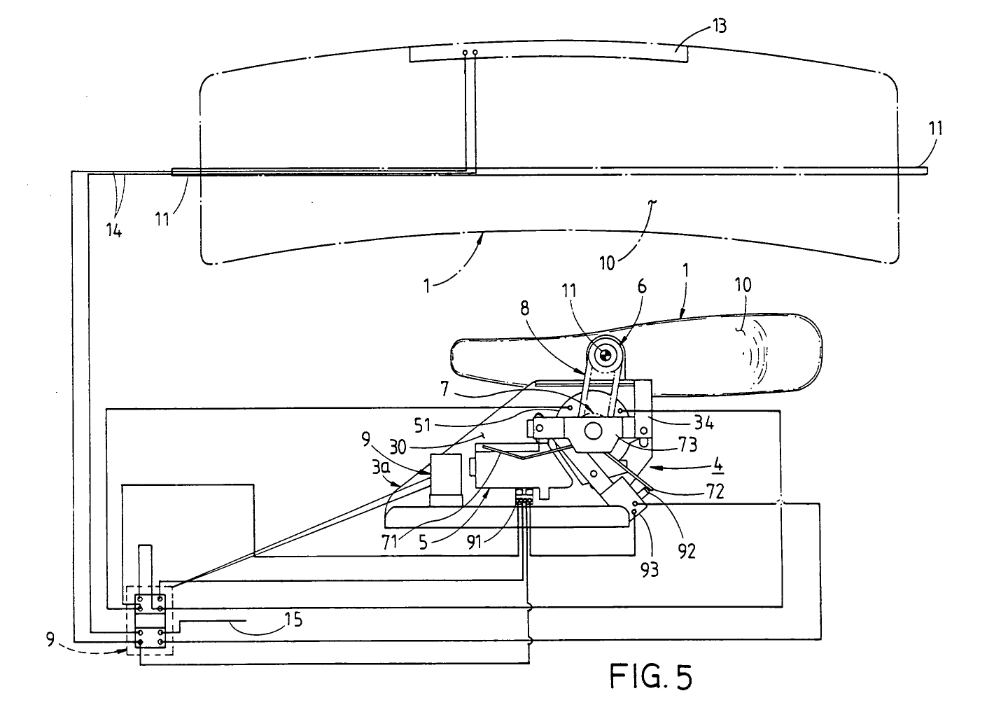

Referring to FIGS. 1 and 2, the swinging disturbing current board for car of the present invention mainly consists of a disturbing current board body 1, left and right holders 2a, 2b (wherein the left holder 2a and right holder 2b are the same structure and corresponding to each other but not shown in the drawings), a left fixed beam 3a and a right fixed beam 3b installed in the left and right holders 2a, 2b respectively for pivotal assembly with the disturbing current board body 1 with a rubber pad 22 disposed on the lower side of the beam body 30 thereof and then fixed on the rear trunk lid of the car or in the position nearby the rear end (side) thereof (not shown in the drawings); a disturbing current board driving mechanism 4 disposed on the fixed beam 3a in the holder 2a actuates the disturbing current board body 1 swinging and raising the rear edge thereof up about 30°-60° in an inclined state from its original slightly horizontal state so as to light a third stop light 13 disposed on the said rear edge of disturbing current board body 1. As shown in FIG. 3, the board body 10 of disturbing current board body 1 is a long rectangular bar or a slightly-arcked rectangular bar or a board body with a shape similar thereto made of plastic or glass fiber or material similar thereto through molding, and each one shaft 11 is provided at the two ends of said board body 10 to pivotally assemble with the said fixed beams 3a, 3b; the peripheral edge of said board body 10 has to be in an arcked reverse angle 12 so as to lower the resistance of wind. A third stop light 13 is disposed in the central position on the rear edge of the board body 10 (as shown in FIG. 2); a wire 14 of the third stop light 13 is extended out from a shaft 11 on the disturbing current board body 1 to connect a relay 9 (as shown in FIG. 5) and then connect in parallel with a power source wire 15 of the stop light 13 on the car (omitted in the drawings). The length, width or integral shaping and sectional shape of the board body 10 of disturbing current board body 1 and the dimensions, shape and modeling of the holders 2a, 2b may be designed according to the different cars and their categories, models and brands. As indicated in FIGS. 1 and 3, the left and right holders 2a, 2b are slightly trapezoid lid body 20 (the cross-section of said lid body 20 is slightly flat reverse U-shaped section); a hole 21 is provided on one side in a position nearby the upper edge of the lid body 20 to pivotally assemble with the shafts 11 on the two sides of board body 10 of the disturbing current board body 1. The left and right fixed beams 3a, 3b are slightly trapezoid and L-shaped beam body 30; a bearing seat 31 is provided respectively at the upper end of each beam body 30 so as to install a bearing (not shown in the drawings) and pivotally assemble with the shafts 11 at the two ends of board body 10 of disturbing current board body 1. At least two holes 32 have to be provided on the bottom of each beam body 30 so as to install the beam body 30 on the rear trunk lid of the car or in a position nearby the rear end (side) thereof; some slots 33 or holes and threaded apertures (not shown in the drawings) have to be provided on the beam body 30 of a (left) fixed beam 3a so as to fix various members of the disturbing current board driving mechanism 4; and meantime, a reverse L-shaped board 34 has to be provided and extended to one side of bearing seat 31 at the upper end of beam body 30 of the fixed beam 3a so as to help fix the decelerating device 51 of motor 5, lower chain wheel 7 and starting capacitor 93 of the disturbing current board driving mechanism 4 (as shown in FIG. 4).

The disturbing current board driving mechanism 4, referring to FIGS. 3 and 4, mainly consists of a motor 5 provided with a decelerating device 51, an upper chain wheel 6, a lower chain wheel 7, a chain 8, a relay 9, an upper limit switch 91, a lower limit switch 92 and a staring capacitor 93; all of them are installed on the (left) fixed beam 3a in the (left) holder 2a, wherein an upper limit switch opening and closing board 71 and a lower limit switch opening and closing board 72 provided respectively on the two lower sides of lower chain wheel 7 are fixed on the shaft of decelerating device 51 of the motor 5 and then fixed in a position between the beam body 30 of fixed beam 3a and the reverse L-shaped board 34 by means of a chain wheel fixed beam 73; the upper chain wheel 6 is fixed on the shaft 11 on one side of the board body 10 of disturbing current board body 1, and the chain 8 is disposed in a position between the upper and lower chain wheels 6, 7; the upper limit switch 91, the lower limit switch 92 and the starting capacitor 93 are installed respectively on the beam body 30 of fixed beam 3a in a suitable position on the lower left and right sides of the lower chain wheel 7; the relay 9 is fixed in a suitable position at the bottom of beam body 30 of fixed beam 3a by means of a relay seat 94 in keeping with the starting capacitor 93 and the upper and lower limit switches 91, 92 to control the motor 5 actuating the decelerating device 51 to operate turning clockwise and counterclockwise as well as opening and closing. As shown in FIG. 5, the wiring thereof includes the relay 9 provided with a power source wire 15 for connection in parallel with the power source line of stop light on the car.

After the present invention is installed on the rear trunk lid of the car (not shown) or in a position nearby the rear end (side) thereof and the wiring is finished but before driving the car or foot-operating the brake while driving the car forward, the disturbing current board body 1 of the present invention is in a slightly horizontal state as indicated in FIG. 5; however, when starting up the car or foot-operating the brake while driving the car forward, the power source of relay 9 is turned on, the motor 5 turns clockwise to drive the decelerating device 51, actuating the lower chain wheel 7 to turn and further actuating the rear edge of board body 10 of disturbing current board body 1 to swing and raise up about 30°-60° angle in an inclined state as indicated in FIG. 6 (the third stop light 13 on the disturbing current light body 1 is lighting at the same time), and then the upper limit switch opening/closing board 71 on the lower chain wheel 7 contacts the upper limit switch 91 to turn off the power source of relay 9 and to stop the motor 5 running; however, when the brake is released, the power stored in the starting capacitor 93 is provided to the motor 5 to turn counterclockwise driving the decelerating device 51 to actuate the lower chain wheel 7 turning and to further actuate the rear edge of board body 10 of disturbing current board body 1 to swing down and restore its original slightly horizontal state as shown in FIG. 5, the lower limit switch opening/closing board 72 contacts the lower limit switch 92 to turn off the power source of relay 9 once again, the motor 5 stops running once again, and the disturbing current board body 1 is kept in a slightly horizontal state. When foot-operating the brake once again, the foregoing operations are repeated once again; no matter the raising angle of disturbing current board body 1 is enough or not, the disturbing current board body 1 can restore its horizontal state automatically.

1. A swinging disturbing current board for car comprising:
a disturbing current board body and left and right holders, wherein a left fixed beam and a right fixed beam are respectively installed in each one holder for pivotal assembly with the disturbing current board body to be fixed on the rear trunk lid of the car or in a position nearby the rear end (side) thereof, which is characterized in:
a disturbing current board driving mechanism installed on the fixed beam in a holder;
a shaft provided at each one of two ends of said disturbing current board body as a long rectangular bar or a long rectangular bar slightly arcked;
a third stop light provided in the slightly central position on the rear edge of said board body, and the wire of said stop light extended from the center of said shaft and connected in parallel with a power source wire of the stop light on the car.

2 As mentioned in claim 1, the left and right fixed beams are slightly trapezoid beam bodies with a slightly L-shaped section, which further include:
a bearing seat provided on each one of beam bodies for installing a bearing and pivotally assembling with said shafts at the two ends of disturbing current board body;
some slots, holes or threaded apertures provided on each beam body, and a reverse L-shaped board extended to and provided on one side of said bearing seat at the upper end of beam body so as to install a disturbing current board driving mechanism on the said beam body.

3 The disturbing current board driving mechanism in claim 2 comprising:
a motor with a decelerating device, an upper chain wheel, a lower chain wheel, a chain, a relay, an upper limit switch, a lower limit switch and a starting capacitor, wherein the upper and lower limit switch opening/closing boards provided respectively on the two lower sides of lower chain wheel are fixed on the shaft of decelerating device of motor and then fixed in a position between the beam body of fixed beam and the reverse L-shaped board by means of a chain wheel fixed beam;
the upper chain wheel is fixed on the shaft on one side of said disturbing current board body;
the chain is disposed in a position between the upper and lower chain wheels;
the upper and lower limit switches and the starting capacitor are installed respectively on the beam body of fixed beam in a suitable position on the lower left and right sides of the lower chain wheel;
the relay is fixed in a suitable position at the bottom of beam body of fixed beam by means of a relay seat in keeping with the starting capacitor and the upper and lower limit switches to control the motor actuating the decelerating device to operate turning clockwise and counterclockwise as well as opening and closing; and the relay has to be provided with a power source wire for connection in parallel with the power source line of stop light on the car.

4 A swing disturbing current board for car as claimed in claim 1, wherein the length, width or integral shaping and sectional shape of the board body of disturbing current board body and the dimensions, shape and modeling of the holders may be designed according to the different cars and their categories, models and brands.
